(19) United States
(12) Patent Application Publication
(10) Pub. No.: US 2010/0108732 A1
(43) Pub. Date: May 6, 2010

(54) BUNDLE BREAKER

(76) Inventors: Craig Gendreau, Spokane, WA (US); Michael Harrington, Spokane, WA (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/572,837

(22) Filed: Oct. 2, 2009

Related U.S. Application Data
(60) Provisional application No. 61/102,495, filed on Oct. 3, 2008.

(51) Int. Cl. B26F 3/02; B65H 3/44

(52) U.S. Cl. 225/1; 271/17; 225/97

(57) ABSTRACT

The present disclosure relates to a bundle separator for separating bundles from a log traveling along a conveyor, the log having a plurality of stacked sheets with a weakened separation path, and the weakened separation path of each sheet being substantially aligned in the stack. The separator includes a first platen mounted for vertical reciprocating movement generally on a first side of the separation path and a second platen mounted for vertical reciprocating movement generally on a second side of the separation path, each platen having a plurality of moveable guided rails. The second platen is also mounted for movement away from the first platen. The moveable guided rails on each of the first and second platens are each independently moveable in the upstream or downstream direction of travel of the log.

### CROSS-REFERENCE TO RELATED APPLICATIONS

This application claims priority to U.S. Provisional Application No. 61/102,495 filed on Oct. 3, 2008, the contents of which are incorporated in their entirety herein by reference.

### FIELD OF THE INVENTION

The present disclosure relates to machines commonly referred to as bundle breakers or bundle separators, which separate a plurality of stacked sheets, particularly along a separation path or a nick line. More particularly, the present disclosure relates to improvements for bundle breakers.

### BACKGROUND OF THE INVENTION

Bundle separators or bundle breakers separate a plurality of stacked sheets, or bundles, from a log of stacked sheets. Each sheet is divided by one or more weakened paths or separation paths, and similarly, each log is divided by one or more weakened paths or separation paths. Bundle breakers in the corrugated board industry are typically located in a production line between a sheet stacker on the upstream side and a load former, which arranges the bundles in pallet loads, on the downstream side.

A wide variety of products are manufactured in elongated sheets and divided into smaller segments through the use of weakened paths in the sheets created by, for example, scoring, indenting, nicking, tabbing, or punching. Such products include composition house roofing shingles, glass plates, paper, plastic, and corrugated board used in constructing boxes and packaging material. Weakened paths are provided since it is desirable, with such products, to impose tensile stress required to separate the sheets along the selected paths rather than subjecting the entire sheet to tensile stress with random separation.

In the manufacture of corrugated boxes and other corrugated goods, for example, a large sheet of corrugated material is passed through a machine which will die cut the blank or flat shape of corrugated boxes, or other objects that are to be constructed, from the sheet of corrugated material. The sheets of corrugated material may be die cut in a press, which acts in the manner of a die cutting machine, to stamp the pattern of the blank into the sheets. Alternately, the sheets of corrugated material may pass through a rotary die which will cut and/or emboss the blank pattern of the final shape of the knock-down cartons or the like to be made from the sheets.

To simplify handling of the corrugated material, the die cut blanks are not separated completely from the sheet, but are left partially joined along adjacent edges which will separate under tension to produce the individual blanks for later formation into cartons, boxes, or other objects. Because several blanks may be separated from a single sheet, there is an increase in efficiency from handling a single sheet as compared to a multitude of blanks cut from the sheet.

At some point, the blanks defined by the rotary press or the platen die press will need to be separated so that they may be individually bundled and shipped or further processed into finished goods. In the manufacture of corrugated goods, it is desirable to enhance efficiency and throughput by minimizing handling steps. It is therefore desirable to separate the blanks from the primary sheet or sheets in a minimal number of steps.

One method to minimize the number of handling steps is to collect several sheets into a stack, or log, and then separate the log into bundles. The more sheets in a log of corrugated material that can be handled at one time, the more efficient the process will be. However, as more sheets are accumulated into a log to increase throughput, a larger force will be required to separate a log along a defined separation path.

Some die cutting processes will cut away portions of the corrugated sheet along the separation path of the blank to be separated from the sheet. In the cut away area, small tabs will be left so the blank does not separate from the sheet. The small tabs are termed “nicks,” and a sheet with die cut blanks held in place by nicks is termed a “nicked sheet.” Alternately, the die may impress a crease along the sheet or partially cut through the sheet to define the separation path. Either of these processes will create an area of weakened tensile strength such that when the sheet is subjected to a tensile force acting generally in the plane of the sheet, the sheet will tear or separate along the defined separation path.

One method for separating a bundle of blanks from a log of nicked sheets consists of grasping the log of corrugated sheets along either side of a separation path and then pulling the two grasped portions apart to sever the bundle from the remaining log. As the stacks include an increasing number of sheets, more tensile force is required to separate the bundle from the log to increase the rate of throughput. In order to achieve greater tension forces, larger grasping or clamping forces must be applied to the stack.

An example bundle breaker can include a first conveyor for conveying the log of stacked sheets, the first conveyor having an upstream end for receiving the log of stacked sheets and a downstream end. A second conveyor includes an upstream end positioned immediately adjacent the downstream end of the first conveyor. The bundle breaker includes a first clamp or platen mounted for vertical reciprocating movement generally above the first conveyor and a second clamp or platen mounted above the second conveyor for vertical reciprocating movement generally above the second conveyor. The platens above the first and second conveyors are allowed to move away from each other once a log of stacked sheets has been clamped on either side of the separation path in order to separate a bundle of stacked sheets from the log of stacked sheets. Several embodiments of bundle breakers are known, such as the bundle breakers described in U.S. Pat. No. 5,791,539, U.S. Pat. No. 6,019,267, U.S. Pat. No. 6,655,566, and U.S. Pat. No. 7,370,783, each of which is hereby incorporated by reference herein in its entirety. Nonetheless, the above-identified prior art bundle breaker systems do not provide the most efficient handling of logs of stacked sheets, wherein the sheets are die cut or embossed with irregular or non-linear separation paths.

Thus, there exists a need in the art for an apparatus for separating bundles of blanks from a log of nicked sheets having such blanks die cut within the individual sheets and which allows the platens to be positioned generally as closely as possible to the separation path to allow separation with less force and less risk of damage to the materials. There is a need in the art for an improved bundle breaker including platen shoes, or guided rails, that can be moved longitudinally to position clamping force generally as close to the separation path as possible.

### BRIEF SUMMARY OF THE INVENTION

The present disclosure, in one embodiment, relates to an apparatus for separating bundles from a log traveling along a conveyor, the log having a plurality of stacked sheets with a weakened separation path, and the weakened separation path of each sheet being substantially aligned in the stack. The apparatus includes a first platen mounted for vertical reciprocating movement generally on a first side of the separation path and a second platen mounted for vertical reciprocating movement generally on a second side of the separation path, each platen having a plurality of moveable guided rails. The second platen is also mounted for movement away from the first platen. The moveable guided rails on each of the first and second platens are each independently moveable in the upstream or downstream direction of travel of the log.

The present disclosure in another embodiment relates to an apparatus for separating bundles from a log including a plurality of stacked sheets having a top surface, each sheet having a weakened irregular separation path, the weakened irregular separation path of each sheet being substantially aligned in the stack and defining a downstream bundle for separation from an upstream portion of the log. The apparatus includes a first platen and a second platen, each having a plurality of guide rails, each of the guide rails being independently moveable in the upstream or downstream directions. The first platen releasably clamps down on the upstream portion of the log, and the second platen releasably clamps down on the downstream bundle. Generally the entirety of the guide rails of the first platen remain on the upstream side of the weakened irregular separation path and generally the entirety of the guide rails of the second platen remain on the downstream side of the weakened irregular separation path during separation of the downstream bundle from the log.

The present disclosure, in another embodiment, relates to a method for separating a bundle of stacked sheets from a log of sheets. The method includes conveying the log of sheets until a weakened separation path defined across the log of sheets is brought to a desired position. A plurality of moveable guided rails provided on each of first and second platens are positioned such that leading edges of the guided rails substantially align with the profile of the weakened separation path. The log of sheets is clamped on one side of the weakened separation path under the plurality of guided rails of the first platen and on the other side of the weakened separation path under the plurality of guided rails of the second platen. Substantially no portion of the weakened path is covered by a guided rail.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying Figures, in which:

FIG. 1 is a perspective view of a single sheet illustrating three blanks die cut therein and separation paths defining the individual blanks.

FIG. 2 is a perspective view of a stack of sheets with the respective separation paths substantially aligned.

FIG. 3 is a perspective view of a stack of sheets being broken with a bundle of blanks separating from the remainder of the stack along a separation path.

FIG. 4 is a fragmented plan view of an irregular separation path.

FIG. 5 is a fragmented plan view of another irregular separation path.

FIG. 6 is a plan view of platens of a prior art bundle breaker, wherein the platens are positioned over a stack of sheets having an irregular separation path, the platens overlapping the separation path.

FIG. 7 is a plan view of platens of a prior art bundle breaker, wherein the platens are positioned over a stack of sheets having an irregular separation path, the platens spread further apart from each other such that the platens do not overlap the separation path.

FIG. 8 is a plan view of platens of one embodiment of a bundle breaker in accordance with the present disclosure, the platens having moveable guided rails or platen shoes and being positioned over a stack of sheets having an irregular separation path.

FIG. 9 is a fragmented end view of a platen of one embodiment of a bundle breaker in accordance with the present disclosure, the platen having moveable guided rails or platen shoes.

FIG. 10 is a detailed end view of a platen of another embodiment of a bundle breaker in accordance with the present disclosure, the platen having moveable guided rails or platen shoes.

FIG. 11 is a flow chart of an improved method of separating a bundle from a stack of sheets, wherein the bundle breaker has platens with moveable guided rails or platen shoes in accordance with an embodiment of the present disclosure.

### DETAILED DESCRIPTION

The present disclosure relates to novel and advantageous bundle breakers or bundle separators for separating a plurality of stacked sheets, particularly along a weakened path, separation path, or nick line. More particularly, the present disclosure relates to novel and advantageous improvements for bundle breakers.

An improved bundle breaker according to an embodiment of the present disclosure allows platen shoes, or guided rails, to be moved longitudinally, or in the direction of the material path, to clamp generally as close to the separation path as possible, including generally as close as possible to each portion of the separation path of nested bundles substantially along the length of the separation path. An improved bundle breaker according to an embodiment of the present disclosure works on both non-nested bundles or nested bundles; however, an increased benefit can be achieved particularly with regard to nested bundles. Additionally, an improved bundle breaker according to an embodiment of the present disclosure works for separating multiple stacks simultaneously, including where the multiple stacks are of inconsistent heights.

Currently bundle breaker machines move upstream platens and downstream platens as single units. This means the edge of each platen nearest the nick line will orthogonally traverse the travel path of the sheets from one side to another in an essentially linear edge. In contrast, a bundle breaker of the present disclosure allows individual platen shoes to move longitudinally relative to each other so that the edges of the platen shoes nearest the separation path do not always line up linearly/orthogonally across the travel path of the sheets. This allows the platens to generally conform to the shape of the nested bundle, apply force closer to the separation path, and reduce damage on the materials being separated.

Bundle breakers may be used in the manufacture of a wide variety of products, such as but not limited to composition house roofing shingles, glass plates, paper, plastic, and corrugated board used in constructing boxes and packaging material. While the various embodiments of the present disclosure are described herein as applying primarily to corrugated material, it is understood that the various embodiments of a bundle breaker described herein can be used equally effectively with uncorrugated fiberboard, sheets of plastic, sheets of fiberglass, or other suitable semi-rigid material which lends itself to tearing in tension, such as those listed above. It is also understood that the various embodiments of a bundle breaker described herein may apply equally well to thin sheets of wood.

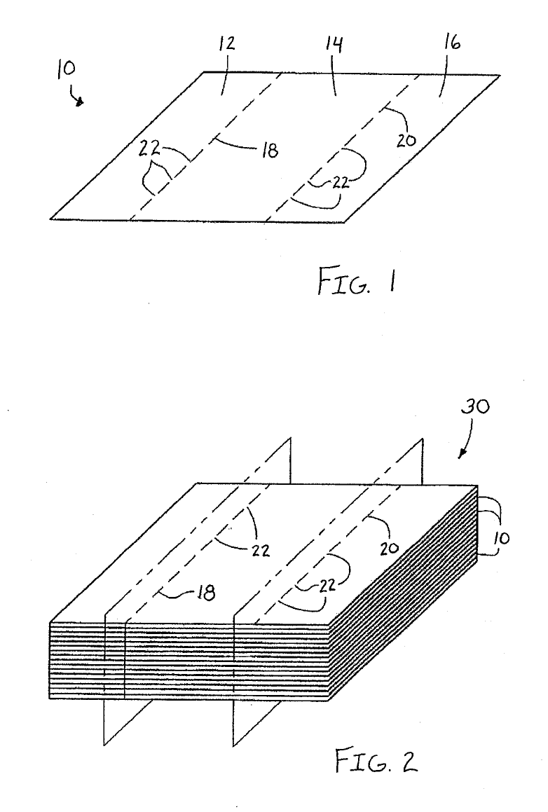

In the manufacture of cardboard boxes and other items made of corrugated material, for example, a large sheet of corrugated material can be processed in a die or other cutting device to cut one or more blanks (flat patterns) from the corrugated sheet. FIG. 1 illustrates a sheet 10 with blanks 12, 14, and 16 formed therein and defined by die cut separation or perforation paths 18 and 20. The separation paths 18, 20 act to weaken the corrugated material at the separation paths 18, 20 so the blanks 12, 14, 16 can be separated at the separation paths 18, 20 to produce multiple bundles from one stack of nicked sheets. As previously discussed, it may not be desirable to completely cut the blanks away from the entire sheet 10, but rather to leave the blanks connected in such a manner that the entire sheet 10 can be handled as a single entity. Separation paths considerably reduce handling time and increase productivity over systems requiring individual handling of the die cut blanks 12, 14, 16. It further should be noted that the various embodiments of the present disclosure allow for separation of a plurality of sheets where not all sheets have a separation path, or where no sheets have a separation path. The various embodiments of the present disclosure may be used to customize a separation path where no prior separation path is formed into the sheets.

Current processes for partially cutting without separating the blanks from the entire sheet may include leaving small tabs 22 along the die cut separation path 18, 20 or embossing or partially cutting along the separation path 18, 20 so as to create “nicks” in the sheet 10. As noted above, a sheet having partially cut blanks may be referred to herein as a “nicked sheet.” Alternately, the die may impress a crease along the sheet or partially cut through the sheet to define the separation path.

At some point in the manufacturing process, it may be desirable to separate the defined blanks from the rest of the nicked sheet 10 so that the blanks 12, 14, 16 may be shipped individually or may be further constructed into completed cartons and the like. As illustrated in FIG. 2, to increase productivity, it can be desirable to perform this separation process such that a number of sheets 10 may be formed into a stack 30 with the separation paths of successive sheets 10 in substantial vertical alignment. The stack 30 may then be grasped on opposite sides of a separation path, such as separation path 20, and placed in sufficient tension to break the nicks and thereby separate a bundle 32 of blanks 16 from the stack 30, as shown in FIG. 3. A bundle 32 may be considered herein as that portion of a stack 30 to be separated, or which has been separated, from the remainder of the stack 30 originally presented for separation. The process can be repeated on the remainder of the stack 30 until all the blanks 12, 14, 16 are separated. Typically, a portion or portions of the separation lines 18, 20 in individual sheets in the stack 30 will be substantially aligned so that they are roughly in a separation zone. However, when a plurality of sheets 10 are stacked together, the separation paths 18, 20 may not align in the separation zone in a plane, such as plane 34, perfectly bisecting the stack 30, but oftentimes may overlap slightly. Therefore, in the present disclosure, when a separation zone is discussed, it is understood that the alignment of the separation paths considered to be within the separation zone may in fact vary within the separation zone and not align in a perfect plane, such as plane 34. Similarly, the separation zone may be any suitably-sized area for accommodating a separation path including an irregular separation path, as discussed in further detail below.

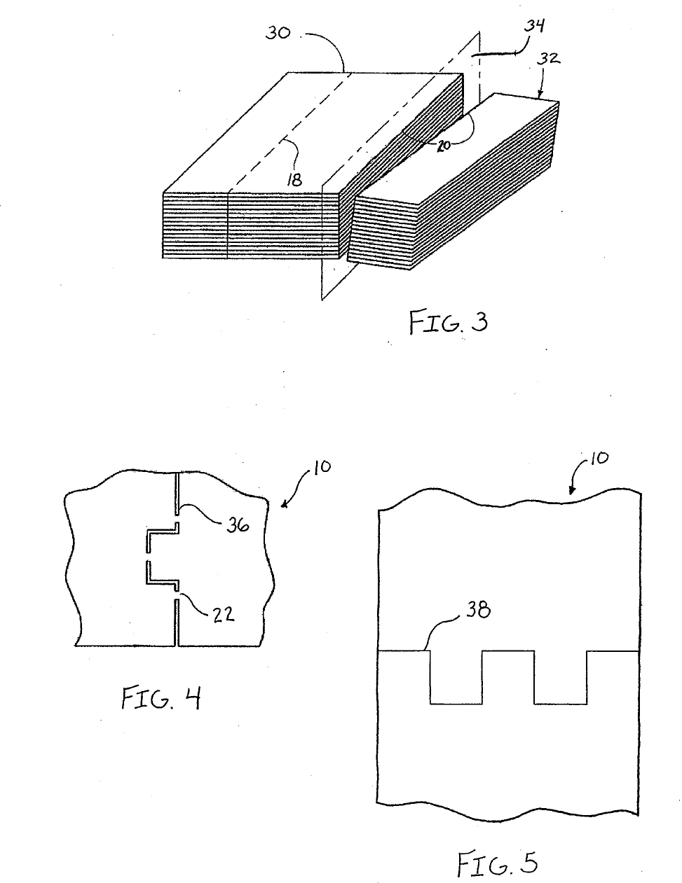

Oftentimes, the separation path 18, 20 will orthogonally traverse the sheet from one side to another creating an essentially straight separation path 18, 20, as illustrated in FIGS. 1-3. In other instances, the separation path may not be a straight path, but rather an irregular path 36, 38, such as is illustrated in FIGS. 4 and 5. As used herein, the term “irregular” when used with respect to a path or separation path may include any path that does not orthogonally traverse the sheet 10 in a straight path from one side of the sheet to the other. Stacks having this characteristic may also be referred to herein as nested bundles. As illustrated in FIGS. 4 and 5, the irregular separation path 36, 38 may be a perforated path 36 having small nicks 22 along the path, may be a crease 38 along the sheet, or any other suitable mechanism for providing a zone, area, or path with weakened tensile strength defining a separation path in the sheet. The separation paths 36, 38 in FIGS. 4 and 5 are examples of separation paths, and it is recognized that any suitably-configured separation path may be used with the various embodiments of the present disclosure, and in many embodiments, the shape of the finished product may dictate the shape of the separation path.

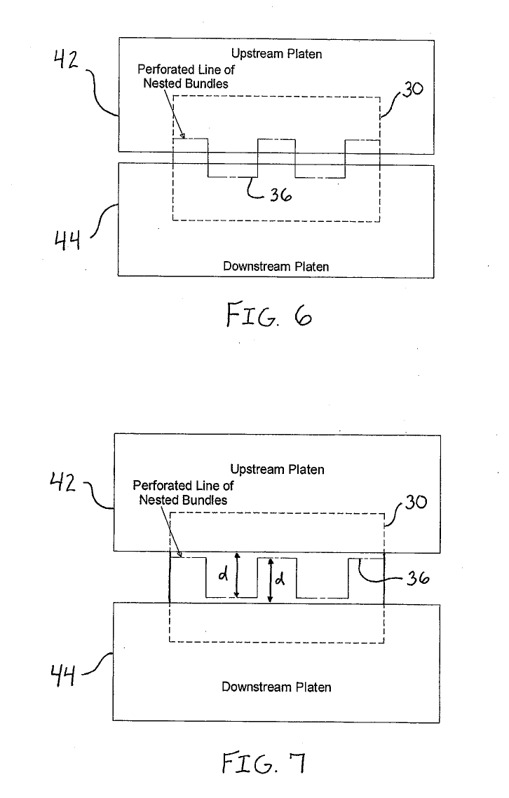

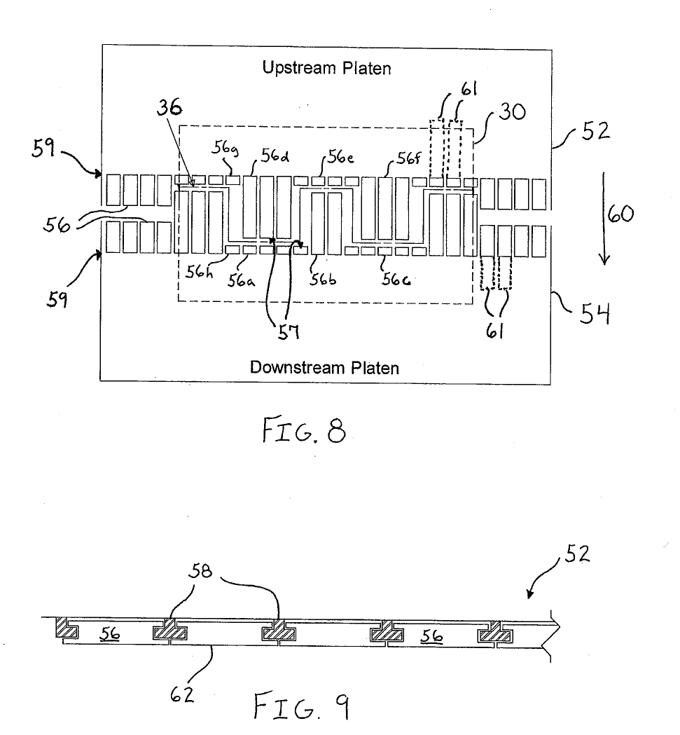

In bundles with a generally straight separation path 18, 20, a system of upstream and downstream platens that are close together and close to the straight separation path 18, 20 can be quite effective. However, with nested bundles, the effectiveness of the prior art systems deteriorates due to a portion of the separation path 36, 38 being clamped between the upstream 42 and downstream 42 platens, as shown in FIG. 6. The efficiency of prior art systems to separate nested bundles is improved by moving the upstream 42 and downstream 44 platens away from the straight separation path 36 and clamping them upstream and downstream, respectively, of any portion of separation path 36, as shown in FIG. 7. However, moving the platens 42, 44 away from the separation path to accommodate the nested bundle becomes less effective as the distance d from the edges of the platens 42, 44 and the separation path 36 increases.

In certain embodiments, it can be desirable that the bundles are clamped and controlled as near to the separation path as possible. For instances where nested bundles must be separated, the separation can be most effective when the platens follow the profile of the separation path. The present disclosure relates particularly to an improvement for a bundle breaker, and more particularly to a bundle breaker having improved platens for efficiently and accurately separating bundles, particularly nested bundles, from a stack.

In an effort to increase the efficiency of separating nested bundles using upstream 52 and downstream 54 platens, guided rails 56, also referred to herein as platen shoes, can be used to adapt the shape of the platens 52, 54 to generally that of the separation path 36. In one embodiment, illustrated in FIG. 8, there may be numerous individual guided rails 56 that are supported in retainers 58 (FIG. 9) and are adjustable in the longitudinal direction of the material path 60. The embodiment of FIG. 8 shows one example and is for illustrative purposes only. There may be any suitable number of rails 56 on either platen 52, 54. Additionally, each rail 56 may be of any desirable width; however, in one embodiment, the widths of the rails 56 are generally equal. Similarly, each rail 56 may be configured for any suitable amount of longitudinal extension and retraction; however, in one embodiment, the amount of longitudinal extension of each of the rails 56 is generally equal. Furthermore, for purposes of illustration, FIG. 8 generally only shows those portions of the guided rails 56 that are nearest the separation path, i.e., the portions between illustrative planes 59. However, it is recognized that, in some embodiments, each of the rails 56 may be a substantially common length and, in some embodiments, portions of the rails 56 may extend beyond illustrative planes 59 and further into platens 52, 54, as is shown by dashed lines 61.

The leading edges 57—the edges of each of the rails 56 of each platen 52, 54 that is nearest the separation path—of the individual rails 56 can be set up to accommodate the particular separation path 36 profile of the nested bundles at the beginning of a log of sheets, for example, and may generally be maintained in that position (except vertically as required for clamping/grasping) until the next log of sheets is presented to the bundle breaker. Alternatively, the individual rails 56 can be set up dynamically upon presentation of each separation path to a separation area, such as but not limited to an area lying generally between the upstream 52 and downstream 54 platens, or at any other suitable time. The individual rails 56 may be set up manually or may be set up automatically by the bundle breaker using appropriate control hardware and/or software. In some embodiments, the bundle breaker may include sensors, such as optical sensors, for determining the separation path 36, 38 to automatically determine and set up the alignment of the individual rails 56, in some cases at each presentation of a separation path.

In one embodiment, both the upstream platen 52 and downstream platen 54 can be provided with multiple rails, e.g., 56a, 56b, 56c, that are paired with a rail, e.g., 56d, 56e, 56f, respectively, on the opposite platen. However, in other embodiments, the rails 56 of the upstream platen 52 do not necessarily need to be paired with the downstream platen 54. The rails 56 can move upstream and downstream, and all rails 56 can move independent of all other rails. In scenarios where the separation path 18, 20 is straight across the stack 30, a leading edge of the rails 56 can be substantially aligned orthogonally across and close to the separation path.

However, when separating nested bundles, the rails 56 can adjust upstream or downstream so that the leading edge of each rail 56 is substantially near its respective portion of the separation path 36 profile when in a clamped position, as illustrated in FIG. 8. When a rail, e.g., 56g, 56h, would overlap a separation path 36 that runs in the direction of the material path 60, the upstream and downstream rail pair 56g, 56h may retract so as not to clamp across the separation path. The rails 56 can accommodate substantially any irregular separation path that is suitable for separation by a bundle breaker. The rails 56 allow the platens to generally conform to the shape of the nested bundle to allow separation with less force and less risk of damage to the materials.

As can be seen in FIG. 9, which illustrates a fragmented end view of a platen 52 of one embodiment of a bundle breaker in accordance with the present disclosure, the guided rails 56 may each be longitudinally moveable relative to the rest of the platen 52 along rail retainers 58. The rail retainers 58 can allow longitudinal movement of the guided rails 56 while also maintaining the guided rails 56 adjacent to the remaining portions of the platen 52. As can also be seen in FIG. 9, the guided rails 56 may each have a generally planar contact surface 62, which together provide a generally planar surface for clamping or grasping the stack of sheets 30 when the platen is moved vertically so that it is adjacent to, and grasping, the stack of sheets 30. In other embodiments, the guided rails 56 may be provided with a contact surface 62 that is not substantially planar or is textured, such as with nubs or ridges, providing a relatively less slippery contact surface 62 with added grasping power. In alternative embodiments, a contact member or contact foot may provided on a surface of the guided rails 56, wherein the contact member provides the contact surface for clamping or grasping the stack of sheets 30 when the platen is moved vertically so that it is adjacent to, and grasping, the stack of sheets 30. The contact member may be provided on, or comprise, a portion of the lower surface of the rails 56 or may be provided on, or comprise, substantially all of the lower surface of the rails 56. The contact member may be any shape, including but not limited to, square, rectangular, triangular, polygonal, irregular, combinations of these, etc.

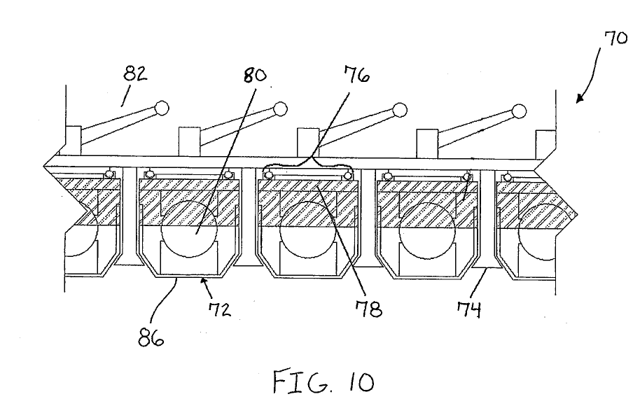

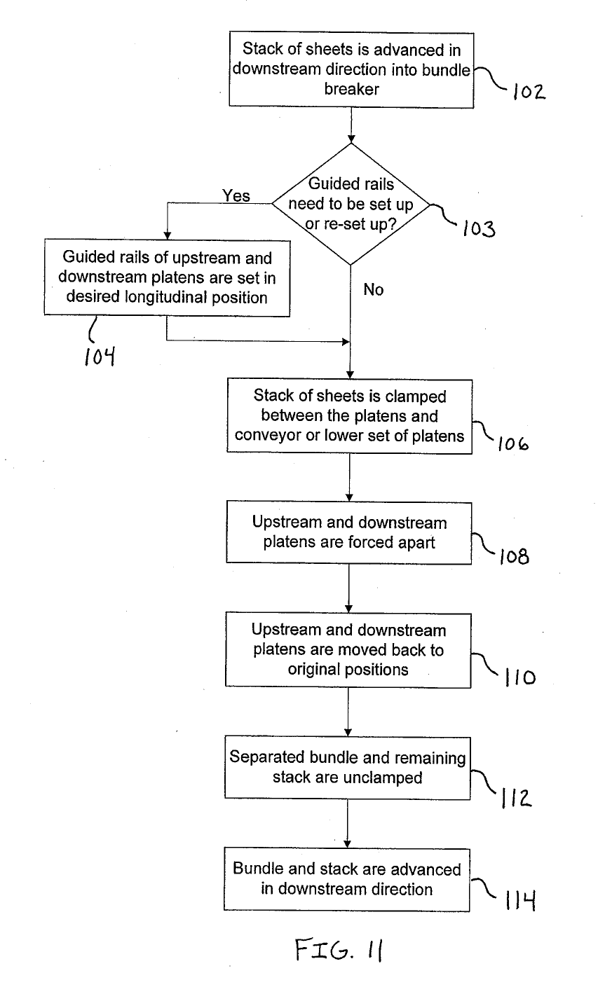

FIG. 10 illustrates a more detailed fragmented end view of a platen 70 of another embodiment of a bundle breaker in accordance with the present disclosure, wherein the platen 70 includes moveable guided rails or platen shoes 72. The guided rails 72 may each be individually, longitudinally moveable (i.e., into or out of the page as illustrated, or more generally, in the same or opposite direction of log travel) relative to the rest of the platen 70 along rail retainers 74. As stated, the rail retainers 74 can allow longitudinal movement of the guided rails 72 while also maintaining the guided rails 72 adjacent to the remaining portions of the platen 70. Linear bearings 76, or other suitable bearing or lubrication means, may be provided between sliding plates 78 of the guided rails 72 and the platen 70 to ease or assist in the longitudinal movement of the guided rails 72. The sliding plates 78 may have a generally planar surface for contact with the linear bearings 76. The guided rails 72 may be moved longitudinally manually by hand or using other suitable mechanisms, such as a linear actuator or the like, or automatically, also with the use of suitable mechanisms, such as a linear actuator or the like, in order to position each of the guided rails 72 to its desired longitudinal position, described above. For example, in one embodiment, to extend the guided rail 72 out from the edge of the platen 70, the guided rail 72 may be moved by hand or (manually or automatically) through use of its respective actuator, etc. to the desired position. A similar manner can be used to retract the guided rail 72 to a desired position. In some embodiments, a handle 82, or other suitable actuation device, such as a button, lever, switch, etc., may be provided for locking or unlocking the guided rail 72 in the desired position.

As can also be seen in FIG. 10, the guided rails 72 may have a generally planar contact surface 86, which together provide a generally planar surface for clamping or grasping the stack of sheets 30 when the platen 70 is moved vertically so that it is adjacent to, and grasping, the stack of sheets 30. In other embodiments, the guided rails 72 may be provided with a contact surface 86 that is not substantially planar or is textured, such as with nubs or ridges, providing a relatively less slippery contact surface 86 with added grasping power. A fluid pressurized compliant structure, such as air/fluid bladders 80 or other suitable mechanism, can be provided for each individual guided rail 72 to assist the generally planar contact surface 86 of each rail 72 in interfacing with a surface of the stack of sheets 30. Providing the guided rails 72 with a fluid pressurized compliant structure, such as an air/fluid bladder 80 may allow the contact surface 86 of each rail 72 to make substantially complete contact with the surface of the sheet, even as the guide rail may move in the upstream or downstream direction. While reference has been made in the disclosure to the surface of a sheet being substantially planar, in other embodiments the guided rails 72 may be used with logs wherein the surface of the logs are not substantially planar or are otherwise uneven. Similarly, the guided rails 72 may be used to clamp and separate bundles from multiple logs, including multiple logs which may differentiate in height, or otherwise be uneven in height. In such embodiments, the guided rails 72 can allow the platen to substantially conform to the non-planar surface of the logs by using the fluid pressurized compliant structure to substantially or generally conform the contact surface or surfaces of the guide rails to the non-planar surface or surfaces of each log or logs. That is, whether substantially planar or non-planar, the air/fluid bladder 80, in one embodiment, may allow the contact surface 86 of each individual rail 72 to substantially align with a surface of the stack of sheets 30 to clamp or grasp the stack of sheets 30. In some embodiments, the bladders 80 may be separate and independent from one another. In further embodiments, a plurality of the bladders 80 can be interconnected with one another such that they can be managed as a single unit.

As described above, the individual rails 72 can be set up to accommodate the particular separation path 36 profile of the nested bundles at the beginning of a log of sheets, for example, and may generally be maintained in that position (except vertically as required for clamping/grasping) until the next log of sheets is presented to the bundle breaker. Alternatively, the individual rails 72 can be set up dynamically upon presentation of each separation path between the upstream and downstream platens or at any other suitable time. The individual rails 72 may be set up manually or may be set up automatically by the bundle breaker using appropriate control hardware and/or software. In some embodiments, the bundle breaker may include sensors, such as optical sensors, for determining the separation path 36, 38 to automatically determine and set up the alignment of the individual rails 72, in some cases at each presentation of a separation path. In some embodiments, where the individual rails 72 are automatically aligned, the handle 82 may be eliminated, or may be used as a manual overdrive for the air/fluid bladder 80.

Components of the bundle breaker, including but not limited to the platens, guided rails, air bladders, conveyors, etc., may be implemented by actuating the components by use of solenoids, relays, and other control schemes known for actuating electric motors, hydraulic and pneumatic actuators, and other mechanisms necessary for actuating machinery.

FIG. 11 illustrates a flow chart diagram of an improved method of separating a bundle 32 from a stack of sheets 30, wherein the bundle breaker has platens with moveable guided rails or platen shoes in accordance with an embodiment of the present disclosure. Generally, the separation of the bundles 32 can be performed automatically in a bundle breaker that accepts a log or stack of sheets 30 with the bundles 32 defined by separation paths 18, 20, 36, 38.

In the first step 102 of one method of separating a bundle from a log or stack of sheets according to the present disclosure, a stack of sheets 30 of material from which a bundle 32 is to be separated is urged forward in the downstream direction by conveyor, which typically may comprise two separate conveyors, one generally below the upstream platen 52 and one generally below the downstream platen 54 of the bundle breaker. However, any suitable means of conveying the stack of sheets can be used to move the stack of sheets in the downstream direction. The stack of sheets 30 can be conveyed into the bundle breaker until the first separation path 18, 20, 36, 38 is brought to the desired position in the bundle breaker. In some embodiments, the desired position may be defined by an area lying generally between the upstream 52 and downstream 54 platens. However, the desired position may be defined at any other suitable location, such that the separation path between the bundle 32 and the remainder of the stack 30 is positioned at the desired position. Once the separation path has been located to the desired position, the conveyor(s) may be stopped and the stack 30 held stationary in the bundle breaker.

In the second step 103, it may be determined whether the guided rails 56 need to be set up or re-set up. For example, in step 104, according to one embodiment, if the bundle 32 to be separated from the stack of sheets 30 will be the first bundle 32 separated from the stack 30, then each of the individual guided rails 56 of each of the upstream 52 and downstream 54 platens may be set to its desired longitudinal position according to the separation path profile. If the separation path is substantially linear across the stack 30, then the guided rails 56 may be aligned substantially linearly so as to substantially align with the separation path 18, 20 of the stack. However, if the separation path is irregular, then the guided rails 56 may be moved longitudinally to substantially align with the separation path 36, 38 profile. As stated above, the guided rails 56 may be aligned manually or may be aligned automatically by the bundle breaker using appropriate hardware and/or software. In some embodiments, the bundle breaker may include sensors, such as optical sensors, for determining the separation path 18, 20, 36, 38 to automatically determine and automatically set up the alignment of the individual rails 56.

In many embodiments, the separation path 18, 20, 36, 38 between each bundle and the remaining stack 30 may be generally similar, if not substantially identical. Therefore, if the bundle 32 to be separated from the stack of sheets 30 will not be the first bundle 32 separated from the stack 30, but instead is a subsequent bundle, then each of the individual guided rails 56 of each of the upstream 52 and downstream 54 platens may already be set to its desired longitudinal position. In such an embodiment, no further alignment of the guided rails 56 is necessary, and step 106 (described below) can proceed following the determination in step 103.

However, in some embodiments, the separation path 18, 20, 36, 38 between each bundle and the remaining stack 30 may be generally different, or alternate or randomly alternate between two or more configurations throughout the stack. Similarly, each of the individual guided rails 56 of each of the upstream 52 and downstream 54 platens may, even where the separation path 18, 20, 36, 38 between each bundle and the remaining stack are generally similar, need to be realigned or adjusted as the stack 30 continues to move through the bundle breaker and new separation paths are continuously presented. Therefore, in some embodiments, each of the individual guided rails 56 of each of the upstream 52 and downstream 54 platens may be set to its desired longitudinal position at each presentation of a separation path 18, 20, 36, 38 or at predetermined or random intervals of separation paths 18, 20, 36, 38 in order to accurately align the guided rails 56 to the specific separation path 18, 20, 36, 38 to be separated. As stated above, the guided rails 56 may be aligned manually or may be aligned automatically by the bundle breaker using appropriate hardware and/or software. In some embodiments, the bundle breaker may include sensors, such as optical sensors, for determining the separation path 18, 20, 36, 38 to automatically determine and set up or readjust the alignment of the individual rails 56.

Once the guided rails 56 are aligned to their desired longitudinal position and once the separation path is brought to the desired position, the upstream 52 and downstream 54 platens can be actuated and lowered, in a generally vertical direction, to a position where the stack 30 is appropriately clamped or grasped between the platens 52, 54 and the conveyors or a set of lower platens, as indicated by step 106 of FIG. 11. As stated above, a fluid pressurized compliant structure, such as air/fluid bladder, or other suitable mechanism, can be provided for each guided rail to assist the generally planar contact surface of each rail in interfacing with a surface of the stack of sheets. The clamping forces applied by the platens 52, 54 may be predetermined and may further be controlled by a control system (e.g., a system that controls the clamp force exerted on the reciprocating platen structure, separate from, or in addition to, any control system for controlling air pressure in the fluid pressurized compliant structure described above), including sensors provided on the bundle breaker or a portion or portions thereof for determining the amount of force applied by the platens 52, 54.

After the specified clamping force is achieved, the upstream 52 and downstream 54 platens can be forced apart, as shown in step 108 of FIG. 11, thereby separating the bundle 32 at the separation path 18, 20, 36, 38 resulting in a smaller, separated bundle 32 which can be conveyed from the bundle breaker for palletizing or further processing. In some embodiments, the upstream 52 and downstream 54 platens can be forced apart by moving one of the platens away from the other platen, for example, by moving the downstream platen 54 away from the upstream platen 52, or vice versa. Alternatively, both the upstream 52 and downstream 54 platens may be moved in a direction away from the other platen. However, it is recognized that any method of moving the platens 52, 54 relative to each other can be used. Similarly, the platens 52, 54 do not necessarily need to be moved in directly opposite directions, but may be moved away from each other in other manners, such as the manner described in U.S. Pat. No. 5,791,539, which was previously incorporated herein by reference.

In one embodiment, indicated in step 110, once the bundle 32 has been separated from the remainder of the stack 30, the platens 52, 54 may be unclamped from the bundle 32 and stack 30. In step 112, the bundle 32 and stack 30 may be unclamped by actuating and raising the upstream 52 and downstream 54 platens in a generally vertical direction away from the bundle 32 and stack 30.

In other embodiments, the bundle 32 and/or stack 30 may be unclamped prior to returning the platens to a pre-separation position so that any sheets for which the separation line was not entirely aligned correctly within the separation area will be free to slide within the stack 30, rather than being crushed by the sheets in the bundle 32 as the bundle is returned to its pre-separation position with the downstream platen 54.

In step 114, the separated bundle 32 and the remainder of the stack 30 can be advanced in the downstream direction by conveyor such that the next separation path 18, 20, 36, 38 in the stack 30 is brought to the desired position, as described above. In one embodiment, the bundle 32 may be conveyed in the downstream direction first, and after a slight delay, the remainder of the stack 30 may follow in the downstream direction. Advancing of stack 30 can preferably be done after a delay to assure that the separated bundle 32 will completely exit the bundle breaker conveyor before the stack 30 is advanced and positioned for the next separating cycle.

Steps 102 through 114 may then be repeated until the remainder of the stack 30 is a single bundle. At that point, there is no remaining stack 30 for the bundle to be separated and rather than repeating steps 104 through 112, which are steps required for breaking a bundle from the remainder of the stack, the remaining stack portion can be merely advanced through the bundle breaker with the previous bundle separated from the stack.

Using the various embodiments of bundle breakers and methods for separating a bundle 32 from a stack of sheets 30 described herein, throughput may be maximized. Using platens having longitudinally moveable guided rails 56 as described above, the force required to initiate separation of the bundle 32 to be separated from the stack 30 may be reduced. This minimizes the risk of damage to the stack 30 by clamping or grasping the stack 30 too tightly.

Although the present invention has been described with reference to preferred embodiments, persons skilled in the art will recognize that changes may be made in form and detail without departing from the spirit and scope of the invention. For example, in some embodiments, no predefined weakened separation line may be required for certain relatively brittle, or soft or malleable, materials. Using platens having longitudinally moveable guided rails may further assist in separating these materials along an appropriate separation path.

We claim:

1. An apparatus for separating bundles from a log traveling downstream a conveyor, the log comprising a plurality of stacked sheets with a weakened separation path, and the weakened separation path of each sheet being substantially aligned in the stack, the apparatus comprising:
a first platen mounted for vertical reciprocating movement generally on a first side of the separation path and comprising a plurality of moveable guided rails; and
a second platen mounted for vertical reciprocating movement generally on a second side of the separation path and comprising a plurality of moveable guided rails, the second platen further mounted for movement away from the first platen;
wherein the plurality of moveable guided rails on each of the first and second platens are each independently moveable in the upstream or downstream direction of travel of the log.

2. The apparatus of claim 1, wherein the plurality of moveable guided rails on each of the first and second platens are each independently moveable in the upstream or downstream directions, such that leading edges of the guided rails substantially align with the profile of the weakened separation path.

3. The apparatus of claim 1, wherein the first and second platens comprise means for independently extending and retracting each guided rail in the upstream or downstream directions.

4. The apparatus of claim 1, wherein each of the guided rails comprise a generally planar contact surface for contacting a top surface of the log.

5. The apparatus of claim 4, wherein the first and second platens comprise a fluid pressurized compliant structure for each guided rail.

6. The apparatus of claim 5, wherein the first and second platens comprise a fluid pressurized compliant structure for each guided rail.

7. The apparatus of claim 6, wherein the top surface of the log is generally non-planar, and wherein the fluid pressurized compliant structure for each guided rail causes the platen to substantially contact the generally non-planar surface of the log.

8. The apparatus of claim 6, wherein a plurality of the fluid pressurized compliant structures of the first platen are interconnected, and wherein a plurality of fluid pressurized compliant structures of the second platen are interconnected.

9. The apparatus of claim 1, wherein the number of guided rails on the first platen is the same as the number of guided rails on the second platen.

10. The apparatus of claim 9, wherein each of the guided rails on the first platen are paired with an opposing guided rail on the second platen.

11. An apparatus for separating bundles from a log comprising a plurality of stacked sheets having a top surface, each sheet having a weakened irregular separation path, the weakened irregular separation path of each sheet being substantially aligned in the stack and defining a downstream bundle for separation from an upstream portion of the log, the apparatus comprising:
a first platen comprising a plurality of guide rails, each of the guide rails being independently moveable in the upstream or downstream directions; and
a second platen comprising a plurality of guide rails, each of the guide rails being independently moveable in the upstream or downstream directions;
wherein the first platen releasably clamps down on the upstream portion of the log, and the second platen releasably clamps down on the downstream bundle, and wherein generally the entirety of the guide rails of the first platen remain on the upstream side of the weakened irregular separation path, and generally the entirety of the guide rails on the second platen remain on the downstream side of the weakened irregular separation path during separation of the downstream bundle from the log.

12. The apparatus of claim 11, wherein when the first and second platens clamp down, leading edges of the guide rails of the first and second platen substantially conform to the pattern of the weakened irregular separation path.

13. The apparatus of claim 12, wherein each of the plurality of moveable guide rails is supported in a retainer.

14. The apparatus of claim 12, wherein the leading edge of each guide rail is manually positionable adjacent to the weakened irregular separation path.

15. The apparatus of claim 12, wherein the leading edge of each guide rail is automatically positionable adjacent to the weakened irregular separation path.

16. The apparatus of claim 15, further comprising at least one optical sensor for automatically determining the configuration of the weakened path for positioning for the leading edge of each of the guide rails adjacent to the weakened path.

17. The apparatus of claim 12, wherein each of the guide rails further comprises a contact member providing a contact surface for clamping down on the log.

18. A method for separating a bundle of stacked sheets from a log of sheets, comprising:
conveying the log of sheets until a weakened separation path defined across the log of sheets is brought to a desired position;
positioning a plurality of moveable guided rails provided on each of first and second platens such that leading edges of the guided rails substantially align with the profile of the weakened separation path; and
clamping the log of sheets on one side of the weakened separation path under the plurality of guided rails of the first platen and clamping the log of sheets on the other side of the weakened separation path under the plurality of guided rails of the second platen, such that substantially no portion of the weakened path is covered by a guided rail.

19. The method of claim 18, further comprising:
moving the second platen relative to the first platen to separate a bundle of stacked sheets from the log;
returning the second platen to a pre-separation position; and
unclamping the log of sheets from the first and second platens.

20. The method of claim 18, wherein the weakened separation path is irregular.

21. The method of claim 18, wherein positioning the moveable guided rails is done manually.

22. The method of claim 18, wherein positioning the moveable guided rails is done automatically using at least one optical sensor for determining where the profile of the weakened path and adjusting the position of each of the moveable guided rails to be adjacent to the weakened path.
